(19) United States
(12) Patent Application Publication
(10) Pub. No.: US 2026/0072272 A1
(43) Pub. Date: Mar. 12, 2026

(54) DISPLAY DEVICE AND HEAD-UP DISPLAY

(71) Applicant: Japan Display Inc., Tokyo (JP)

(72) Inventor: Chikyu NAKAOKA, Tokyo (JP)

(21) Appl. No.: 19/323,627

(22) Filed: Sep. 9, 2025

(30) Foreign Application Priority Data
Sep. 12, 2024 (JP) 2024-157995

(51) Int. Cl. G02B 27/01; G09G 3/00; G09G 3/36

(52) U.S. Cl. CPC G02B 27/0101; G09G 3/002; G09G 3/36; G02B 2027/0118; G09G 2330/021

(57) ABSTRACT

A display device includes: a light source device configured to emit emission light including first linear polarized light and second linear polarized light; a liquid crystal display panel tilted with respect to an optical axis of the emission light and including a polarization reflection plate on which the emission light is incident and that transmits the first linear polarized light and reflects the second linear polarized light; and a reflection plate configured to reflect the second linear polarized light reflected by the polarization reflection plate toward the liquid crystal display panel. The reflection plate includes: a first plate into which the second linear polarized light reflected by the polarization reflection plate is incident, and configured to impart a quarter wavelength phase difference to the incident light; and a second plate configured to reflect the light transmitted through the first plate, toward the liquid crystal display panel via the first plate.

### CROSS-REFERENCE TO RELATED APPLICATION

This application claims the benefit of priority from Japanese Patent Application No. 2024-157995 filed on Sep. 12, 2024, the entire contents of which are incorporated herein by reference.

### BACKGROUND

### 1. Technical Field

What is disclosed herein relates to a display device and a head-up display.

### 2. Description of the Related Art

As an example of display devices, a head-up display is disclosed in Japanese Patent Application Laid-open Publication No. 2007-65011 (JP-A-2007-65011). The head-up display projects an image onto a light-transmitting object such as a windshield to cause a user to visually recognize a virtual image of the image. The display device disclosed in JP-A-2007-65011 includes a light emitting element, a liquid crystal display panel that transmits light from the light emitting element to project an image, and a reflector that reflects, toward the windshield, light after passing through the liquid crystal display panel. The liquid crystal display panel includes a liquid crystal cell and two polarizers on either side of the liquid crystal cell.

In the display device disclosed in JP-A-2007-65011, the amount of light from the light emitting element (light source device) is reduced by the polarizers. Thus, the light quantity of the light source device is required to be relatively large for allowing the user to visually recognize the image on the display device. As a result, the power consumption of the light source device is relatively large. When the display device is used as a head-up display for a vehicle, for example, the light quantity and power consumption of the light source device are further required to be large for allowing the user to visually recognize the virtual image during the daytime when there is sunlight. On the other hand, there is a desire to reduce the power consumption of the display device.

For the foregoing reasons, there is a need for a display device and a head-up display that can reduce power consumption.

### SUMMARY

According to an aspect, a display device includes: a light source device configured to emit emission light including first linear polarized light and second linear polarized light orthogonal to the first linear polarized light; a liquid crystal display panel including a polarization reflection plate on which the emission light is incident and that transmits the first linear polarized light and reflects the second linear polarized light, the liquid crystal display panel being tilted with respect to an optical axis of the emission light; and a reflection plate configured to reflect the second linear polarized light reflected by the polarization reflection plate toward the liquid crystal display panel. The reflection plate includes: a first plate into which the second linear polarized light reflected by the polarization reflection plate is incident, the first plate being configured to impart a quarter wavelength phase difference to the incident light; and a second plate configured to reflect the light transmitted through the first plate, toward the liquid crystal display panel via the first plate.

According to an aspect, a head-up display includes: a light source device configured to emit emission light including first linear polarized light and second linear polarized light orthogonal to the first linear polarized light; a liquid crystal display panel including a polarization reflection plate on which the emission light is incident and that transmits the first linear polarized light and reflects the second linear polarized light, the liquid crystal display panel being tilted with respect to an optical axis of the emission light; and a reflection plate configured to reflect the second linear polarized light reflected by the polarization reflection plate toward the liquid crystal display panel. The reflection plate includes: a first plate into which the second linear polarized light reflected by the polarization reflection plate is incident, the first plate being configured to impart a quarter wavelength phase difference to the second linear polarized light; and a second plate configured to reflect the light transmitted through the first plate, toward the liquid crystal display panel via the first plate.

### BRIEF DESCRIPTION OF THE DRAWINGS

FIG. 1 is a plan view of a display device according to an embodiment of the present disclosure;

FIG. 2 is a side view of the display device along an X direction;

FIG. 3 is a plan view of a light source device;

FIG. 4 is a cross-sectional view of the light source device;

FIG. 5 is a cross-sectional view of a liquid crystal display panel;

FIG. 6 is a cross-sectional view of a reflection plate;

FIG. 7 is a view of the reflection plate when viewed along a direction orthogonal to a plate surface thereof;

FIG. 8 is a schematic cross-section view of the display device to illustrate a positional relation between the light source device, the liquid crystal display panel, and the reflection plate; and

FIG. 9 is a schematic diagram of a head-up display according to the embodiment of the present disclosure.

### DETAILED DESCRIPTION

The following describes an embodiment of the present disclosure in detail with reference to the accompanying drawings. The present disclosure is not limited to the description of the embodiment given below. Components described below include those easily conceivable by those skilled in the art or those substantially identical thereto. In addition, the components described below can be combined as appropriate.

What is disclosed herein is merely an example, and the present disclosure naturally encompasses appropriate modifications easily conceivable by those skilled in the art while maintaining the gist of the present disclosure. To further clarify the description, the drawings schematically illustrate, for example, widths, thicknesses, and shapes of various parts as compared with actual aspects thereof, in some cases. However, they are merely examples, and interpretation of the present disclosure is not limited thereto. The same element as that illustrated in a drawing that has already been discussed is denoted by the same reference numeral through the description and the drawings, and detailed description thereof will not be repeated in some cases where appropriate.

The X, Y, and Z directions indicated in the drawings are orthogonal to one another and correspond to the width, depth, and height directions of a display device 1, respectively. The X, Y, and Z directions are examples, and the present disclosure is not limited to these directions. In this specification, the description “plan view” means viewing the display device 1 along the Z direction. The description “side view” means viewing the display device 1 along a direction orthogonal to the Z direction (i.e., the directions parallel to the X and Y directions).

### Display Device 1

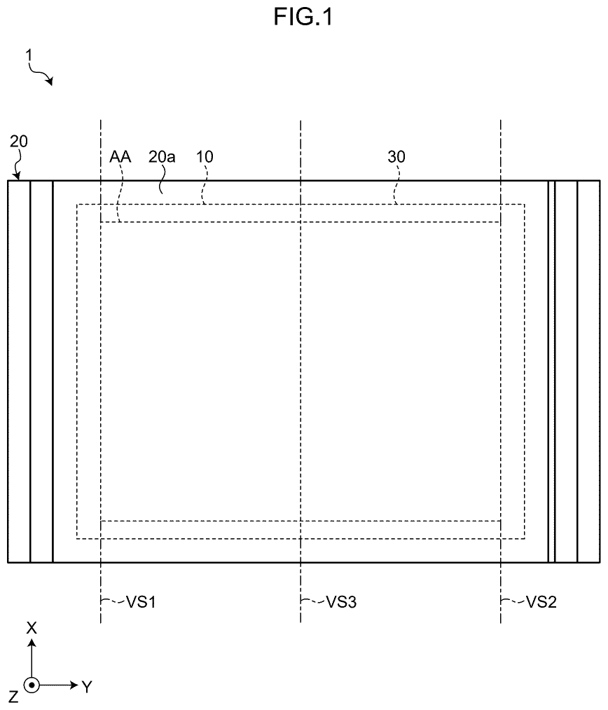

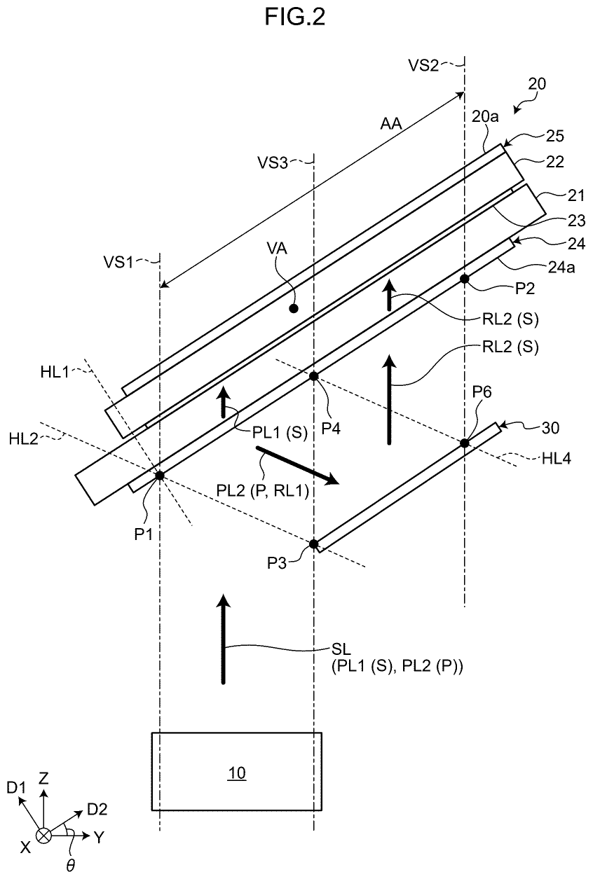

FIG. 1 is a plan view of the display device 1 according to the embodiment of the present disclosure. FIG. 2 is a side view of the display device 1 along the X direction.

The display device 1 is applied to a vehicle navigation system, for example. The display device 1 includes a light source device 10, a liquid crystal display panel 20, and a reflection plate 30.

The light source device 10 emits emission light SL. The optical axis of the emission light SL is along the Z direction. The emission light SL includes a first linear polarized light PL1 and a second linear polarized light PL2. The first linear polarized light PL1 is linear polarized light in a first polarization direction along the X direction that is orthogonal to the Z direction. The second linear polarized light PL2 is linear polarized light in a second polarization direction along the Y direction that is orthogonal to the Z direction. The first and second polarization directions are orthogonal to each other.

Hereinafter, the linear polarized light that is orthogonal to the optical axis and along a plane parallel to the Z and X directions (ZX plane) is referred to as S-polarized light. The linear polarized light that is orthogonal to the optical axis and along a plane parallel to the Z and Y directions (ZY plane) is referred to as P-polarized light. The first linear polarized light PL1 emitted from the light source device 10 corresponds to the S-polarized light while the second linear polarized light PL2 emitted from the light source device 10 corresponds to the P-polarized light. In the drawings, “S” in parentheses added to the sign of the arrow meaning light means that the light is the S-polarized light. Similarly, “P” in parentheses means that the light is the P-polarized light.

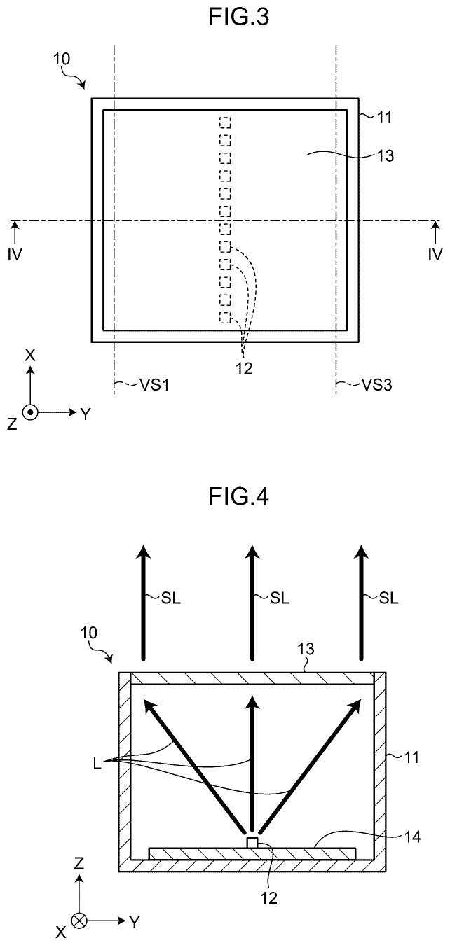

FIG. 3 is a plan view of the light source device 10. FIG. 4 is a cross-sectional view of the light source device 10.

The light source device 10 includes a housing 11, a plurality of light emitters 12, and an optical element 13. The multiple light emitters 12 and the optical element 13 are housed in the housing 11.

The light emitters 12 are arranged on a substrate 14 located on the bottom of the housing 11. The light emitters 12 are arranged in a row along the X direction. The light emitter 12 is a light emitting diode (LED), for example. The light emitter 12 emits light L toward the optical element 13.

The optical element 13 causes the light L from the light emitters 12 to be collimated light when the light source device 10 is viewed along the X direction. The optical element 13 is composed of a plurality of convex lenses, for example. The optical element 13 may be an optical element that causes the light from the light emitters 12 to be collimated light when the light source device 10 is viewed along the X and Y directions. The collimated light emitted from the optical element 13 corresponds to the emission light SL from the light source device 10.

The liquid crystal display panel 20 illustrated in FIGS. 1 and 2 is a transmissive liquid crystal display. The liquid crystal display panel 20 may be an organic electroluminescent display or an inorganic electroluminescent display. The liquid crystal display panel 20 has a display surface 20a that includes an effective region AA in which images are displayed. The effective region AA has a rectangular shape in plan view. Hereinafter, the thickness direction of the liquid crystal display panel 20 is referred to as a first direction D1, and the direction orthogonal to the first direction D1 and the X direction is referred to as a second direction D2.

The liquid crystal display panel 20 is tilted with respect to the optical axis of the emission light SL. Specifically, the liquid crystal display panel 20 is tilted around a virtual axis line VA along the first polarization direction of the first linear polarized light PL1. The virtual axis line VA extends along the X direction. The angle of the liquid crystal display panel 20 with respect to the plane parallel to the X and Y directions (XY plane) is called a tilt angle θ. The tilt angle θ corresponds to the angle between the Y direction and the second direction D2. The tilt angle θ is approximately 10° to 70°.

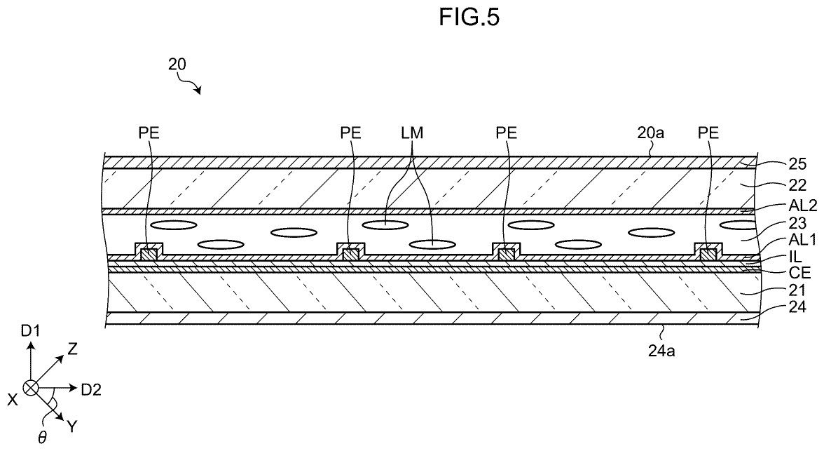

FIG. 5 is a cross-sectional view of the liquid crystal display panel 20. As illustrated in FIGS. 2 and 5, the liquid crystal display panel 20 includes a first substrate 21, a second substrate 22, a liquid crystal layer 23, a polarization reflection plate 24, and a polarizer 25. The first substrate 21 and the second substrate 22 face each other. The liquid crystal layer 23 is disposed between the first substrate 21 and the second substrate 22.

The first substrate 21 is located on a −Z side of the second substrate 22 (the side opposite to the side indicated with the arrow in the Z direction (+Z side)). On and above the surface on the +Z side of the first substrate 21, a first orientation film AL1, an insulating film IL, a common electrode CE, and a plurality of pixel electrodes PE are arranged. The first orientation film AL1 is in contact with the liquid crystal layer 23. The orientation direction of the first orientation film AL1 is along the first polarization direction of the first linear polarized light PL1.

The common electrode CE is disposed between the first substrate 21 and the insulating film IL. The pixel electrodes PE are disposed between the insulating film IL and the first orientation film AL1.

The pixel electrodes PE overlap with the effective region AA when viewed in the Z direction. The pixel electrodes PE overlap with the single common electrode CE when viewed in the Z direction with the insulating film IL interposed between the pixel electrodes PE and the common electrode CE. In this way, the common electrode CE and the pixel electrodes PE are provided to the first substrate 21. In other words, the liquid crystal display panel 20 is a lateral electric field type liquid crystal display.

A second orientation film AL2 is disposed on the −z side of the second substrate 22. The second orientation film AL2 is in contact with the liquid crystal layer 23. The orientation direction of the second orientation film AL2 is orthogonal to the orientation direction of the first orientation film AL1, and along the second polarization direction of the second linear polarized light PL2.

The liquid crystal layer 23 contains a plurality of liquid crystal molecules LM. The initial orientation of the liquid crystal molecules LM is regulated by the first orientation film AL1 and the second orientation film AL2.

The polarization reflection plate 24 is disposed on the −Z side of the first substrate 21. The emission light SL is incident on the polarization reflection plate 24. The polarization reflection plate 24 has a transmission axis along which the first linear polarized light PL1 is transmitted. In other words, the transmission axis of the polarization reflection plate 24 is along the X direction in plan view. The polarization reflection plate 24 reflects the second linear polarized light PL2 by its surface on the −Z side (hereinafter the surface is referred to as a first reflection surface 24a). The first reflection surface 24a corresponds to the surface on the −Z side (back surface) of the liquid crystal display panel 20.

The polarizer 25 is disposed on the +Z side of the second substrate 22. The transmission axis of the polarizer 25 is orthogonal to that of the polarization reflection plate 24. In other words, the transmission axis of the polarizer 25 is along the Y direction and parallel to the second polarization direction of the second linear polarized light PL2 in plan view. The surface on the +Z side of the polarizer 25 corresponds to the display surface 20a.

The liquid crystal layer 23, the polarization reflection plate 24, and the polarizer 25 overlap with the effective region AA in plan view. FIG. 5 illustrates only the main part of the liquid crystal display panel 20 in a simplified form. The liquid crystal display panel 20 further includes additional components that are not illustrated. For example, the second substrate 22 is further provided with a light-shielding layer, a color filter layer, an overcoat layer, and a spacer. The first substrate 21 is further provided with a plurality of scan lines, a plurality of signal lines, and switching elements each electrically coupled to one of the pixel electrodes PE, various insulating films, etc.

The reflection plate 30 illustrated in FIGS. 1 and 2 reflects, toward the liquid crystal display panel 20, the second linear polarized light PL2 reflected by the polarization reflection plate 24. The reflection plate 30 has a rectangular shape with sides extending along the Y direction in plan view. The reflection plate 30 is parallel to the liquid crystal display panel 20.

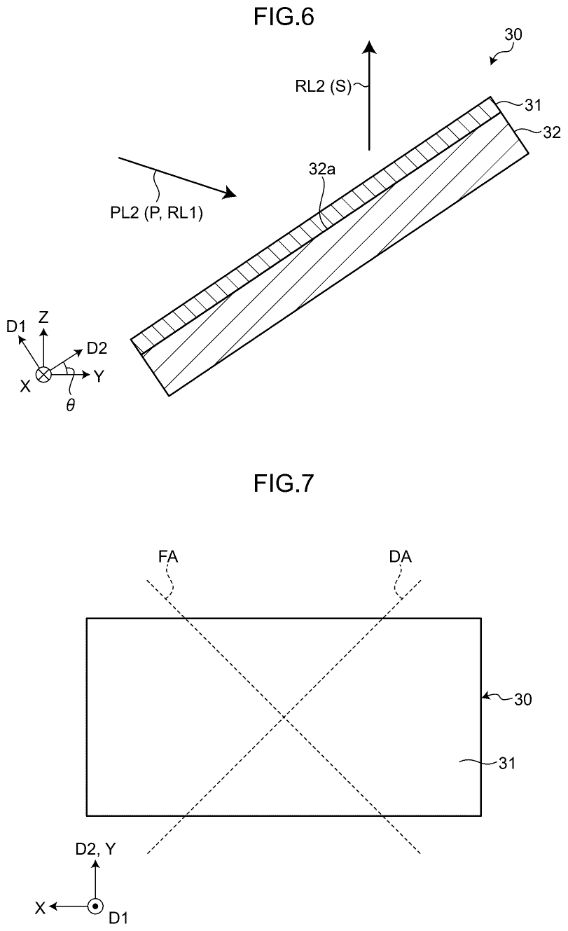

FIG. 6 is a cross-sectional view of the reflection plate 30. The reflection plate 30 includes a first plate 31 and a second plate 32.

The second linear polarized light PL2 reflected by the polarization reflection plate 24 is incident into the first plate 31. The first plate 31 imparts a quarter wavelength phase difference (also described as the ¼ wavelength phase difference) to the incident light. The first plate 31 is a ¼ wavelength phase difference plate.

FIG. 7 is a view of the reflection plate 30 when viewed along a direction orthogonal to the plate surface of the reflection plate 30. The first plate 31 has a fast axis FA and a slow axis DA each of which is tilted at 45° with respect to the second polarization direction of the second linear polarized light PL2, the second polarization direction being along the Y direction.

The second plate 32 illustrated in FIG. 6 reflects the light transmitted through the first plate 31 toward the liquid crystal display panel 20 via the first plate 31. The second plate 32 has a surface that is provided on the +Z side and reflects light. The surface is a mirror surface, for example. The surface corresponds to the “reflection surface” and is hereinafter referred to as a second reflection surface 32a. The light reflectance of the second reflection surface 32a is equal to or larger than 80%. The first plate 31 is adhesively bonded to the second reflection surface 32a with a light-transmitting adhesive layer interposed therebetween, for example.

The thicknesses of the first plate 31 and the adhesive layer are sufficiently smaller than the thickness of the reflection plate 30. The thickness of the first plate 31 is 8 μm, for example. Thus, the thickness of the first plate 31 can be negligible in the reflection plate 30. As a result, the second reflection surface 32a can be regarded as the surface on +Z side (front surface) of the reflection plate 30.

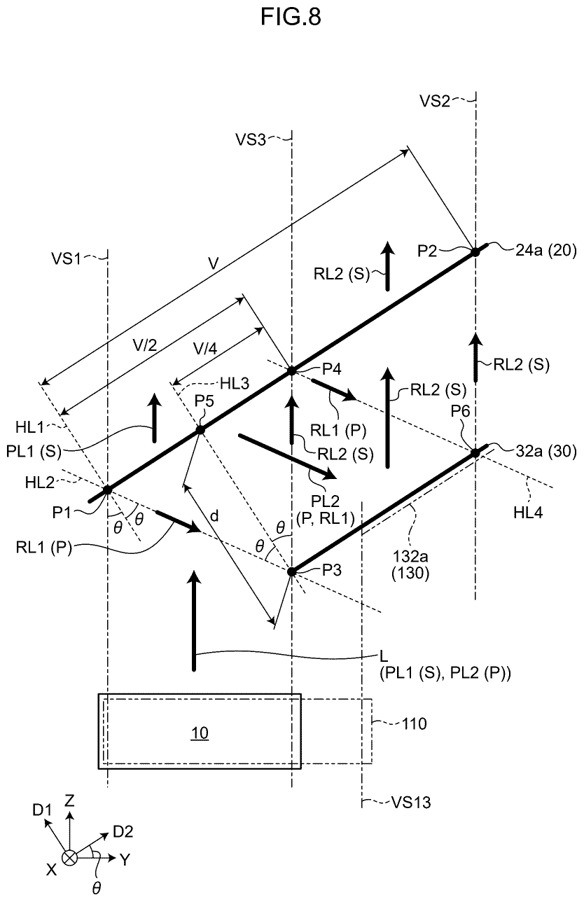

FIG. 8 is a schematic cross-section view of the display device 1 to illustrate a positional relation between the light source device 10, the liquid crystal display panel 20, and the reflection plate 30. FIG. 8 illustrates only the first reflection surface 24a of the polarization reflection plate 24 in the liquid crystal display panel 20. FIG. 8 illustrates only the second reflection surface 32a in the reflection plate 30.

FIGS. 1, 2, 3, and 8 illustrate a first virtual plane VS1, a second virtual plane VS2, and a third virtual plane VS3, which are illustrated by dash-dotted lines. In the first virtual plane VS1, the second virtual plane VS2, and the third virtual plane VS3 illustrated in FIG. 1, the portions overlapping with the dashed lines indicating the effective region AA, the light source device 10, and the reflection plate 30 are indicated with the dashed lines. As described later, the reflection plate 30 is disposed between the liquid crystal display panel 20 and the light source device 10 in the Z direction. FIG. 1 illustrates only the reflection plate 30 in the region in which the reflection plate 30 overlaps with the light source device 10.

The first virtual plane VS1 is orthogonal to the Y direction and passes through the side of the effective region AA on a −Y side. A first point P1 illustrated in FIGS. 2 and 8 indicates the position at which the first reflection surface 24a and the first virtual plane VS1 intersect. The second virtual plane VS2 is orthogonal to the Y direction and passes through the side of the effective region AA on a +Y side. A second point P2 indicates the position at which the first reflection surface 24a and the second virtual plane VS2 intersect.

The third virtual plane VS3 is orthogonal to the Y direction and passes through the side of the second reflection surface 32a on the −Y side. A third point P3 is located on the side of the second reflection surface 32a on the −Y side. The third virtual plane VS3 is placed between the first virtual plane VS1 and the second virtual plane VS2. In the embodiment, the third virtual surface VS3 divides the effective region AA equally in the Y direction. A fourth point P4 indicates the position at which the third virtual plane VS3 and the first reflection surface 24a intersect. In the embodiment, the fourth point P4 corresponds to the midpoint of the first point P1 and the second point P2.

When the display device 1 is viewed along the direction in which the optical axis of the emission light SL extends (Z direction), the light source device 10 and the reflection plate 30 overlap with the liquid crystal display panel 20. When the display device 1 is viewed along the Z direction, there is no gap between the light source device 10 and the reflection plate 30. In other words, the effective region AA overlaps with one of the light source device 10 and the reflection plate 30 in plan view. Specifically, in plan view, the region in the effective region AA between the first virtual plane VS1 and the third virtual plane VS3 overlaps with the light source device 10. In plan view, the region in the effective region AA between the third virtual plane VS3 and the second virtual plane VS2 overlaps with the reflection plate 30.

The reflection plate 30 is located between the liquid crystal display panel 20 and the light source device 10 in the direction in which the optical axis of the emission light SL extends (Z direction). The distance between the reflection plate 30 and the liquid crystal display panel 20 illustrated in FIG. 8 is set such that light reflected toward the liquid crystal display panel 20 by the reflection plate 30 (the second reflection surface 32a) is incident on a region of the polarization reflection plate 24 (the first reflection surface 24a) between the third virtual plane VS3 and the second virtual plane VS2. In the embodiment, the distance between the reflection plate 30 and the liquid crystal display panel 20 is determined to satisfy the following expression (1).

d=V/(4×tan θ) (1)
where d is the distance between the reflection plate 30 and the liquid crystal display panel 20, V is the length of the effective region AA along the second direction D2 (between the first point P1 and the second point P2), and e is the tilt angle.

FIGS. 2 and 8 further illustrate a first auxiliary line HL1, a second auxiliary line HL2, a third auxiliary line HL3, and a fifth point P5. The first auxiliary line HL1 is a virtual line that passes through the first point P1 and is along the first direction D1. The second auxiliary line HL2 is a virtual line that passes through the first point P1 and the third point P3. The third auxiliary line HL3 is a virtual line that passes through the third point P3 and is along the first direction D1. The fifth point P5 indicates the point at which the first reflection surface 24a and the third auxiliary line HL3 intersect.

In FIG. 8, the angle between the first virtual plane VS1 and the first auxiliary line HL1, the angle between the first auxiliary line HL1 and the second auxiliary line HL2, the angle between the second auxiliary line HL2 and the third auxiliary line HL3, and the angle between the third auxiliary line HL3 and the third virtual plane VS3 each correspond to the tilt angle θ. The length between the fourth point P4 and the first point P1 is equal to V/2, and the length between the fourth point P4 and the fifth point P5 is equal to V/4. Furthermore, the distance between the reflection plate 30 and the liquid crystal display panel 20 is equal to the length between the fifth point P5 and the third point P3.

In other words, the distance (d) between the reflection plate 30 and the liquid crystal display panel 20 is calculated from the angle (θ) between the third auxiliary line HL3 and the third virtual plane VS3, and the length (4/V) between the fourth point P4 and the fifth point P5 as represented in expression (1).

The following describes the operation of the display device 1 when the display device 1 displays an image.

The light source device 10 emits the emission light SL toward the liquid crystal display panel 20. The light source device 10 emits the emission light SL from the region including the region between the first virtual plane VS1 and the third virtual plane VS3 in plan view.

The emission light SL travels along the Z direction and is incident on the region of the polarization reflection plate 24 on the −Y side of the third virtual plane VS3. The polarization reflection plate 24 transmits the first linear polarized light PL1 included in the emission light SL.

The polarization reflection plate 24 reflects the second linear polarized light PL2 included in the emission light SL. The second linear polarized light PL2 (hereinafter referred to as first reflected light RL1) reflected by the polarization reflection plate 24 travels along the second auxiliary line HL2, and enters the reflection plate 30. The first reflected light RL1 is the linear polarized light along the second polarization direction. In other words, the first reflected light RL1 is the P-polarized light.

As illustrated in FIG. 8, the first reflected light RL1 reflected at the first point P1 on the first reflection surface 24a travels toward the third point P3 on the second reflection surface 32a. The first reflected light RL1 reflected at the fourth point P4 on the first reflection surface 24a travels toward a sixth point P6 on the second reflection surface 32a. The sixth point P6 indicates the point at which the fourth auxiliary line HL4, which passes through the fourth point P4 and is parallel to the second auxiliary line HL2, and the second reflection surface 32a intersect. The sixth point P6 indicates the point at which the second reflection surface 32a and the second virtual plane VS2 intersect.

The first reflected light RL1 passes through the first plate 31 in the reflection plate 30. The first reflected light RL1 after passing through the first plate 31, to which a ¼ wavelength phase difference is imparted, is reflected by the second reflection surface 32a. Hereinafter, the first reflected light RL1 reflected by the second reflection surface 32a is referred to as second reflected light RL2. The second reflected light RL2 travels along the Z direction and passes through the first plate 31. A ¼ wavelength phase difference is imparted to the second reflected light RL2 after passing through the first plate 31. In other words, the second reflected light RL2 after passing through the first plate 31 has a half (½) wavelength phase difference with respect to the first reflected light RL1 (which is the P-polarized light along the second polarization direction). Thus, the second reflected light RL2 after passing through the first plate 31 is the linear polarized light along the first polarization direction orthogonal to the second polarization direction. In other words, the second reflected light RL2 is the S-polarized light.

The second reflected light RL2 after passing through the first plate 31 is incident on the polarization reflection plate 24. As illustrated in FIG. 8, the second reflected light RL2 reflected at the third point P3 on the second reflection surface 32a travels toward the fourth point P4 on the first reflection surface 24a. The second reflected light RL2 reflected at the sixth point P6 on the second reflection surface 32a travels toward the second point P2 on the first reflection surface 24a.

As described above, the polarization reflection plate 24 has the transmission axis along the first polarization direction. In other words, the polarization reflection plate 24 transmits the second reflected light RL2 (S-polarized light) in the region between the second virtual plane VS2 and the third virtual plane VS3. As described above, the polarization reflection plate 24 transmits the first linear polarized light PL1 (S-polarized light) in the region between the first virtual plane VS1 and the third virtual plane VS3.

As a result, the polarization reflection plate 24 transmits the light along the first polarization direction (S-polarized light) in the region between the first virtual plane VS1 and the second virtual plane VS2 (i.e., the region overlapping with the effective region AA in plan view). As a result, the light along the first polarization direction (S-polarized light) is incident on the liquid crystal display panel 20.

In the liquid crystal display panel 20, an electric field is generated in the liquid crystal layer 23 when voltages are applied to the pixel electrodes PE and the common electrode CE on the basis of an image signal transmitted from an external device, thereby changing the orientations of the liquid crystal molecules LM. This causes the light transmitting through the liquid crystal display panel 20 to be modulated to display an image on the display surface 20a.

The following compares, with the display device 1 in the embodiment, a display device that differs from display device 1 in that the reflection plate 30 is not included, and serves as a comparative example.

In a display device without the reflection plate 30, which is a comparative example, the light source device 10 is required to cause the emission light SL to be incident on the entire effective region AA in plan view. In this case, the light source device 10 overlaps with the entire effective region AA in plan view.

On the other hand, in the display device 1 in the embodiment, the light source device 10 is only required to be disposed such that the light source device 10 overlaps with the region of the effective region AA between the first virtual plane VS1 and the third virtual plane VS3 in plan view. In other words, in the display device 1 in the embodiment, it is possible to reduce the size of the light source device 10 by approximately half of that of the display device serving as the comparative example. Thus, the display device 1 can reduce the power consumption.

When the light source device 10 includes a heat-dissipating member (what is called a heat sink) that dissipates heat of the light emitters 12, the power consumption is reduced as described above, whereby the size of the heat-dissipating member can be reduced.

As described above, the reflection plate 30 is located between the liquid crystal display panel 20 and the light source device 10 in the direction along which the optical axis of the emission light SL extends. Furthermore, when the display device 1 is viewed along the direction in which the optical axis of the emission light SL extends, the light source device 10 and the reflection plate 30 overlap with the liquid crystal display panel 20. As a result, the size of the display device 1 in the embodiment is substantially the same as that of the display device 1 without the reflection plate 30. In other words, the display device 1 in the embodiment can reduce the power consumption without causing the display device 1 to become larger.

### Head-Up Display 2

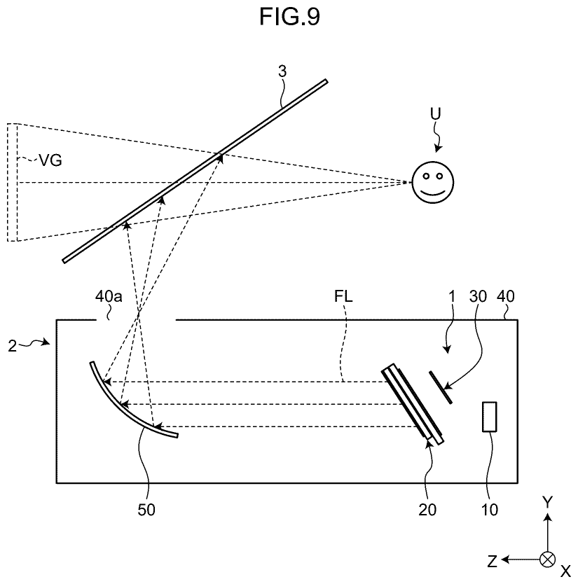

FIG. 9 is a schematic diagram of a head-up display 2 according to the embodiment of the present disclosure. The X, Y, and Z directions illustrated in FIG. 9 are the same as the X, Y, and Z directions illustrated in FIG. 1.

The head-up display 2 (hereinafter referred to as HUD 2) projects an image onto a light-transmitting body 3 to cause a user U to visually recognize a virtual image VG. The light-transmitting body 3 is a windshield, for example, but is not limited to the windshield. Any structure onto which the image of the HUD 2 is projected may be employed as that of the light-transmitting body 3.

The HUD 2 includes a housing 40, the display device 1, and an optical member 50. The housing 40 houses the display device 1 and the optical member 50.

The display device 1 is the above-described display device 1. Light FL emitted from the display device 1 travels toward the optical member 50 along the Z direction.

The optical member 50 guides the light FL emitted from the display device 1 to the light-transmitting body 3 via an opening 40a of the housing 40. The optical member 50 is specifically a concave mirror. The optical member 50 may be composed of a plurality of concave mirrors and reflection mirrors.

The light FL guided by the optical member 50 is projected onto the light-transmitting body 3. The user U looking at the light FL projected onto the light-transmitting body 3 visually recognizes the virtual image VG.

The display device 1 included in the HUD 2 can also reduce the power consumption as described above. The HUD 2 causes the user U to view the virtual image VG, so that the light intensity of the light source device 10 in the HUD 2 is more increased than a case where the user U directly views the display surface 20a of the display device 1. As a result, the power consumption can be efficiently reduced in the HUD 2.

### Modification

The preferred embodiment of the present disclosure are described above. The present disclosure is not limited to such embodiment. The contents disclosed in the embodiment are only examples and various modifications can be made without departing from the purpose of the present disclosure. Appropriate modifications made within the scope that does not depart from the purpose of the present disclosure naturally belong to the technical scope of the present disclosure.

For example, the first linear polarized light PL1 may be the P-polarized light. In this case, the first polarization direction of the first linear polarized light PL1 is along the Y direction. In this case, the second linear polarized light PL2 is the S-polarized light, and the second polarization direction of the second linear polarized light PL2 is along the X direction. Furthermore, in this case, the transmission axis of the polarization reflection plate 24 is along the first polarization direction (Y direction), and the transmission axis of the polarizer 25 is along the second polarization direction (X direction). In this case, the virtual axis line VA illustrated in FIG. 2 is along the second polarization direction (X direction) of the second linear polarized light PL2. In other words, in this case, the liquid crystal display panel 20 is tilted around the virtual axis line VA along the second polarization direction of the second linear polarized light PL2.

A third virtual plane VS13 in the modification illustrated by the dash-dot-dot line in FIG. 8 is located on the second virtual plane VS2 side of the third virtual plane VS3 in the embodiment. In this case, a second reflection surface 132a (a reflection plate 130) in the modification illustrated by the dash-dot-dot line is shorter than the second reflection surface 32a in the embodiment. A light source device 110 in the modification illustrated by the dash-dot-dot line is larger than the light source device 10 in the embodiment. In this case, the reflection plate 130 in the modification may be located closer to the liquid crystal display panel 20 than the reflection plate 30 in the embodiment. In this case, the second reflected light RL2 also is incident on the region of the polarization reflection plate 24 between the third virtual plane VS3 and the second virtual plane VS2.

As a result, the distance (d) between the reflection plate 30 and the liquid crystal display panel 20 may be determined to satisfy the following expression (2) on the basis of the display device 1 in the embodiment and the display device 1 in the modification.

d≤V/(4×tan θ) (2)

On the other hand, when the reflection plate 30 is located further away from the liquid crystal display panel 20 than the reflection plate 30 in the embodiment, the first reflected light RL1 reflected at the first point P1 on the first reflection surface 24a is incident on a portion on the +Y side of the third point P3 of the second reflection surface 32a. In other words, in this case, a region on which the first reflected light RL1 is not incident is generated at the end portion of the second reflection surface 32a on the −Y side. This generates a region on which the second reflected light RL2 is not incident between the third virtual plane VS3 and the second virtual plane VS2 in the polarization reflection plate 24. Thus, the image is not properly displayed on the display surface 20a. In other words, the distance (d) between the reflection plate 30 and the liquid crystal display panel 20 is required to satisfy expression (2).

The reflection plate 30 may be non-parallel to the liquid crystal display panel 20. In this case, the liquid crystal display panel 20 may be a dual-viewpoint display that displays a first image in the direction in which the emission light SL travels (Z direction) and a second image in the direction in which the second reflected light RL2 travels.

Other action effects provided by the modes described in the above-mentioned embodiment that are obvious from description of the present specification or at which those skilled in the art can appropriately arrive should naturally be interpreted to be provided by the present disclosure.

What is claimed is:

1. A display device comprising:
a light source device configured to emit emission light including first linear polarized light and second linear polarized light orthogonal to the first linear polarized light;
a liquid crystal display panel including a polarization reflection plate on which the emission light is incident and that transmits the first linear polarized light and reflects the second linear polarized light, the liquid crystal display panel being tilted with respect to an optical axis of the emission light; and
a reflection plate configured to reflect the second linear polarized light reflected by the polarization reflection plate toward the liquid crystal display panel, wherein the reflection plate includes:
a first plate into which the second linear polarized light reflected by the polarization reflection plate is incident, the first plate being configured to impart a quarter wavelength phase difference to the incident light; and
a second plate configured to reflect the light transmitted through the first plate, toward the liquid crystal display panel via the first plate.

2. The display device according to claim 1, wherein the reflection plate is parallel to the liquid crystal display panel.

3. The display device according to claim 1, wherein the liquid crystal display panel is tilted around a virtual axis line that is along a polarization direction of the first linear polarized light or a polarization direction of the second linear polarized light.

4. The display device according to claim 1, wherein the reflection plate is located between the liquid crystal display panel and the light source device in a direction in which the optical axis of the emission light extends.

5. The display device according to claim 1, wherein the light source device and the reflection plate overlap with the liquid crystal display panel when the display device is viewed along a direction in which the optical axis of the emission light extends.

6. The display device according to claim 1, wherein the liquid crystal display panel includes:
a first substrate provided with the polarization reflection plate;
a second substrate facing the first substrate and disposed such that the first substrate is interposed between the second substrate and the polarization reflection plate;
a liquid crystal layer disposed between the first substrate and the second substrate; and
a polarizer disposed on the second substrate such that the second substrate is interposed between the polarizer and the liquid crystal layer and having a transmission axis parallel to a polarization direction of the second linear polarized light.

7. A head-up display comprising:
a light source device configured to emit emission light including first linear polarized light and second linear polarized light orthogonal to the first linear polarized light;
a liquid crystal display panel including a polarization reflection plate on which the emission light is incident and that transmits the first linear polarized light and reflects the second linear polarized light, the liquid crystal display panel being tilted with respect to an optical axis of the emission light; and
a reflection plate configured to reflect the second linear polarized light reflected by the polarization reflection plate toward the liquid crystal display panel, wherein the reflection plate includes:
a first plate into which the second linear polarized light reflected by the polarization reflection plate is incident, the first plate being configured to impart a quarter wavelength phase difference to the second linear polarized light; and
a second plate configured to reflect the light transmitted through the first plate, toward the liquid crystal display panel via the first plate.
